(19) United States
(12) Patent Application Publication
(10) Pub. No.: US 2005/0212843 A1
(43) Pub. Date: Sep. 29, 2005

(54) Transfer printing workstation

(75) Inventors: Bruce Sanford Jones, Franklin, TN (US); George Jeffrey Elizer, Nashville, TN (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Nu-kote International, Inc.

(21) Appl. No.: 10/807,793

(22) Filed: Mar. 24, 2004

(51) Int. Cl. B41M 5/20

(52) U.S. Cl. 347/19

(57) ABSTRACT

A workstation for producing a printed article using a quantity of a transferable marking substance includes a workstation frame, an output device and a transfer press. Each of the output device and transfer press is supported on the frame. The output device is adapted to output a transfer sheet having an imaged form thereon from the transferable marking substance. The transfer press has a heating element suitable for transferring the marking substance from the transfer sheet to the article. A method of providing a custom printed article is also disclosed.

The present invention broadly relates to the art of transfer printing and, more specifically, to a workstation suitable for producing custom printed articles using a transfer printing process.

### BACKGROUND OF THE INVENTION

Custom printed articles, such as those having a personalized image and/or message there on, for example, are generally well known and commonly produced. Such custom printed articles typically include t-shirts, hats, computer mouse pads and other cloth or cloth covered items. In some instances, other articles can be custom printed as well. These can include non-cloth items, such as polymeric plaques and license plates as well as ceramic mugs and plates, for example.

To date, people desiring custom printed objects have generally had two options for purchasing the same. One, a person could patronize a while-you-wait type of shop or kiosk that creates and/or personalizes an image, and then immediately produces and sells one or more articles having the image thereon. Two, an interested person could order a similar custom printed article from a print shop or other such business, and wait days or weeks for the article to be produced and delivered. While both types of business are common, each of these options has significant disadvantages associated therewith.

Typically, articles produced by while-you-wait type shops and kiosks are made using an “iron-on” type decal or appliqué. Such decals are often highly customizable and normally produced from a digital image that has been modified using software. Modifications to the image can include the addition of text and/or other graphics in one or more of a wide variety of colors, as well as altering the size and/or shape of the image. Once modified, the image is thereafter printed on a decal using a suitable printer, such as an inkjet printer, for example. The decal can then be easily positioned on the article and secured thereto in any well known manner.

One disadvantage of the decals or applique's used by such while-you-wait shops, however, is that the decals are only applied to the outer surface of the article. The decal is typically adhered to the outer surface of the article, such as by using a heat-activated adhesive, for example. Since the decals do not become part of the fabric of the article, these decals tend to have reduced durability from that of the article upon which the decal is applied. In some cases, these decals can have reduced colorfastness as well. This often results in the article having an undesirable appearance after a relatively short period of use.

Another disadvantage of such decals is that the edges of the decal are typically visible and clearly distinguishable from the article upon which the decal has been applied. This tends to detract from the appearance and quality of the resulting custom printed article. Furthermore, the decal forms a second layer of material on the article. This makes the portion of the article covered by the decal less flexible than the remainder of the article. Due at least partly to the nature and use of the article, this can be a bigger issue in some articles, such as t-shirts, for example, than it is with other articles, such as computer mouse pads, for example.

Alternately, custom printed products can be ordered from a print shop or other similar business entity. Typically, these shops produce articles that have the ink or dye forming the personalized image transferred directly into the fibers or structure of the article, rather than applying a decal to the outer surface thereof. As such, articles produced in this manner tend to have greater durability and improved colorfastness over those made using decals. One example of such a transfer printing method is dye sublimation transfer printing. However, products from such print shops are typically not available on a while-you-wait basis. Rather, the custom printed article is typically ordered, and then picked up by the customer or delivered thereto one or more days or weeks later. This is a significant disadvantage, as customers often want to take the custom printed article with them to avoid delivery charges or to avoid making a second trip to the print shop to pick up the article.

Another disadvantage of ordering customized articles from a print shop is that it is often not possible to view the customized image prior to production of the printed article. That is, the customer typically communicates to a print shop employee the customer's vision of what the customized article should look like. The customer typically attempts to communicate this vision verbally and by using sketches, and even by referencing pre-designed samples or illustrations. The print shop then later generates the image to be applied to the article. One disadvantage with this approach, however, is that these communications from the customer are often made to a person other than the one producing the customized image and article. As such, some portion of the communication from the customer is often lost in the transfer between employees. Another disadvantage is that since the customized image is usually produced after the customer has left the premises; the customer is often unable to view the customized image prior to picking up the finished article. Unfortunately, at this point, it is typically too late to refine or revise the image to provide an improved or more desirable end product.

Another difficulty with using ink or dye transfer techniques is related to the temperatures that are typically used in these processes, such as dye sublimation transfer printing processes, for example. This difficulty more specifically relates to the production of relatively thin, flat, plastic articles, such as customized license plates and plaques, for example. It is well known that such plastic articles normally retain residual stresses from the original production thereof. By subjecting these articles to sufficiently high printing temperatures, these residual stresses can be relieved causing the article to warp. This, of course, is undesirable. As such, the production of these types of articles have traditionally been left to print shops and other such businesses rather than while-you-wait type operations due to the availability of suitable heat dissipation surfaces as well as the time to allow the articles to properly cool.

Another difficulty with using ink or dye transfer techniques to produce custom printed articles is that of properly aligning the transfer image on the unprinted article. At least a part of the challenge here is due to the fact that the ink or dye forming the image faces the article to be printed. Since the transfer sheets are typically opaque, it can be difficult to position the transfer image on the unprinted article in proper place. Furthermore, achieving the proper alignment can be made even more difficult by the fact that the image that is transferred from the transfer sheet is actually a mirror image of the desired, customized image. What's more, the article and transfer sheet must then be loaded into the transfer press without inadvertently moving the transfer sheet relative to the unprinted article. As such, articles printed using this process have traditionally been left to print shops and other such businesses rather than while-you-wait type operations due to the potential for production of improperly aligned products.

### SUMMARY OF THE INVENTION

A workstation for producing a printed article using a transferable marking substance is provided and includes a workstation frame, an output device supported on the frame and a transfer press that is also supported on the workstation frame. The output device is adapted to output a transfer sheet having an image formed thereon from a transferable marking substance. The transfer press has a heating element suitable for transferring the marking substance from the transfer sheet to the article.

A retail system for producing a printed article having a customer-provided image is provided and includes an image input device for receiving the customer-provided image. A processor is in communication with the image input device and is adapted to output data corresponding to the mirror image of the input image from the input device. An output device is in communication with the processor and is adapted to receive the data corresponding to the mirror image of the input image. The output device is suitable for producing a transfer sheet having the mirror of the image formed thereon from a quantity of transferable dye. A transfer press has a heating element adapted to transfer the dye on the transfer sheet to the article thereby forming the image thereon.

A retail kiosk for production and sale of a printed article having a customer-provided image is provided and includes a kiosk structure and a storage device supported on the kiosk structure for receiving a digitized version of the customer-provided image. A processor is supported on the kiosk structure and is in communication with the storage device. The processor is adapted to output data corresponding to a mirror image of the digitized version of the customer-provided image. An output device is supported on the kiosk structure and is in communication with the processor. The output device is adapted to output a transfer sheet having the mirror image thereon formed from a quantity of transferable dye. A transfer press is supported on the kiosk structure and has a heating element suitable for transferring the dye onto an unprinted surface of an article.

A heat dissipation element adapted for operative association with a transfer printing workstation is provided and includes a body having a substantially planar top wall and an opposing bottom wall. The bottom wall including a transfer surface increasing the surface area of the body.

A transfer printing fixture for use in operative association with an unprinted article and a printed transfer sheet having a peripheral edge is provided and includes a lower portion having a first peripheral edge and an upper portion having a second peripheral edge. A cavity is formed in at least one of the lower portion and the upper portion and is dimensioned to receive at least a portion of the unprinted article. At least one of the first and second peripheral edges is accessible such that the peripheral edge of the transfer sheet can be aligned therewith.

### BRIEF DESCRIPTION OF THE DRAWINGS

FIG. 1 is a front elevation view of one embodiment of a workstation in accordance with the present invention.

FIG. 2 is a cross-sectional view of the workstation in FIG. 1 taken along line 2-2 in FIG. 1.

FIG. 3 is a schematic representation of an image input and customization system of the workstation in FIG. 1.

FIG. 4 is a perspective view of one embodiment of a heat dissipation element in accordance with the present invention.

FIG. 5 is a bottom plan view of the heat dissipation element in FIG. 4.

FIG. 6 is an exploded perspective view of one embodiment of a transfer template in accordance with the present invention shown in association with an article and a transfer sheet.

FIG. 7 is an exploded perspective view of another embodiment of a transfer template in accordance with the present invention shown in association with a plurality of articles and a transfer sheet.

FIG. 8 is a top plan view of another embodiment of a transfer template in accordance with the present invention.

FIG. 9 is an exploded cross-sectional view of the alignment template in FIG. 8 taken along line 9-9 in FIG. 8 and shown in association with an article and a transfer sheet.

FIG. 10 is a flow chart representing a first portion of a method of providing a custom printed article in accordance with the present invention.

FIG. 11 is a continuation of the flow chart in FIG. 10.

### DETAILED DESCRIPTION OF PREFERRED EMBODIMENTS

As initial background information and to establish some terminology, it will be helpful to briefly discuss transfer printing methods as are well known- by those of skill in the art. Generally, transfer printing methods include a step of moving or causing the movement of a marking substance from one surface to another. This can be contrasted with other printing methods, such as screen printing, for example, that form an image directly on the unprinted surface using free-form ink or another suitable fluid.

Transfer printing methods, such as dye sublimation transfer printing, for example, include steps of forming an image on a first surface, article or substrate and then transferring the image from the first surface to a second surface, article or substrate. Using dye sublimation transfer printing as an example, the image on the first surface is typically a mirror image of that desired on the resulting printed article. This mirror image can be formed on the transfer sheet in any suitable manner, such as by printing the image on the transfer sheet using an output device, such as an ink jet printer, for example. The printed transfer sheet is then placed in abutting engagement with the unprinted article such that the image to be transferred is facing the article and properly positioned thereon. The article and transfer sheet are then heated to cause the dye to sublimate and transfer from the sheet to the article. This is usually performed within a press that forces the sheet tightly against the article.

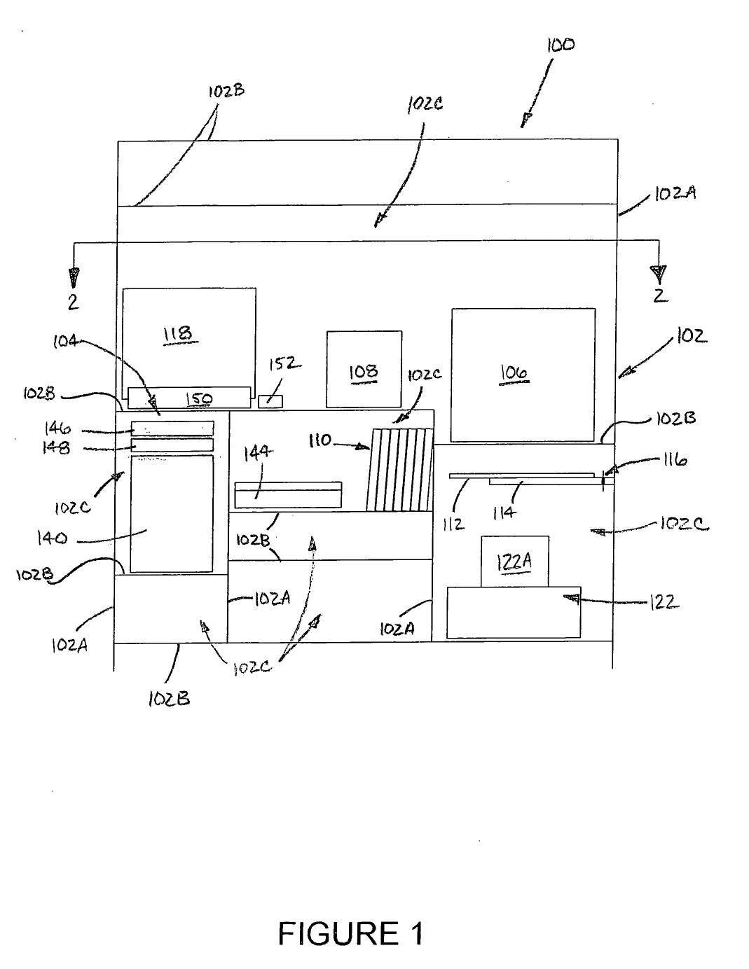

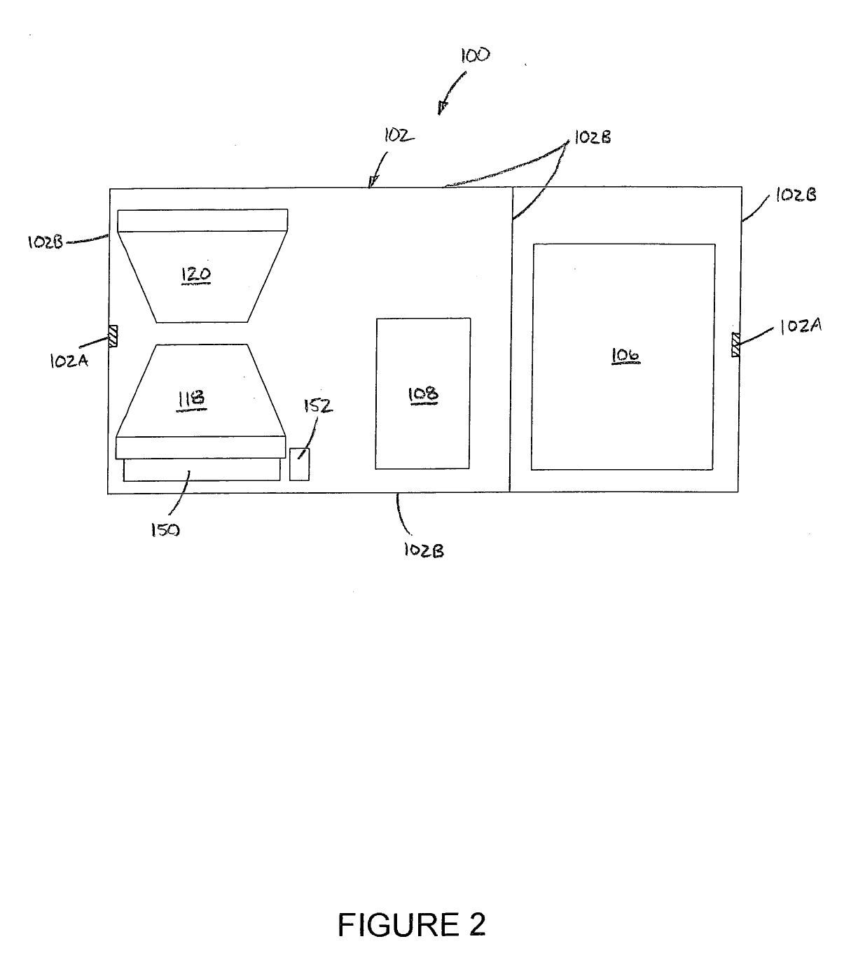

Referring now to the drawings wherein the showings are for the purposes of illustrating preferred embodiments of the invention only, and not for the purposes of limiting the invention, FIGS. 1 and 2 illustrate a workstation 100 that includes a structural frame 102 having vertical supports 102A and horizontal supports 102B that together form a rigid, free standing structure having cavities 102C. Suitable platforms or support surfaces (not shown) extend along or between the horizontal supports, and rollers, casters or other floor engaging members (not shown) can optionally be provided on frame 102 to improve the portability of the same. The cavities are suitable for storing unprinted articles (not shown), such as t-shirts, hats, computer mouse pads, mugs and plates, for example, as well as other supplies. Additionally, supported on structural frame 102 are an image input and modification system 104, a first transfer press 106, a second transfer press 108, and a plurality of alignment fixtures 110. Workstation 100 also includes a heat dissipation element 112 that is pivotally supported on structural frame 102. Element 112 is secured to a plate 114 which is in turn attached to structural frame 102 by a suitable hinge 116.

Additionally, supported on structural frame 102 and used in association with system 104 are displays 118 and 120. Furthermore, an output device, such as a printer 122, for example, is also supported on structural frame 102 and used in association with system 104. Printer 122 is adapted to output transfer sheets 122A having a marking substance (not shown) forming an image thereon.

Transfer presses 106 and 108 are generally well known and commonly used. The transfer presses can be of any suitable kind, type and/or configuration. For example, transfer press 106 can include an upper, vertically displaceable platen (not shown) and a lower, fixed platen (not shown). The upper and lower platens are each substantially planar, and are adapted to compressively retain an unprinted article and a printed transfer sheet in abutting engagement with one another. Additionally, at least one of the upper and lower platens preferably includes a heating element, as is well known by those of skill in the art, to heat the unprinted article and transfer sheet facilitating the transfer of the image on the transfer sheet to the initially unprinted article.

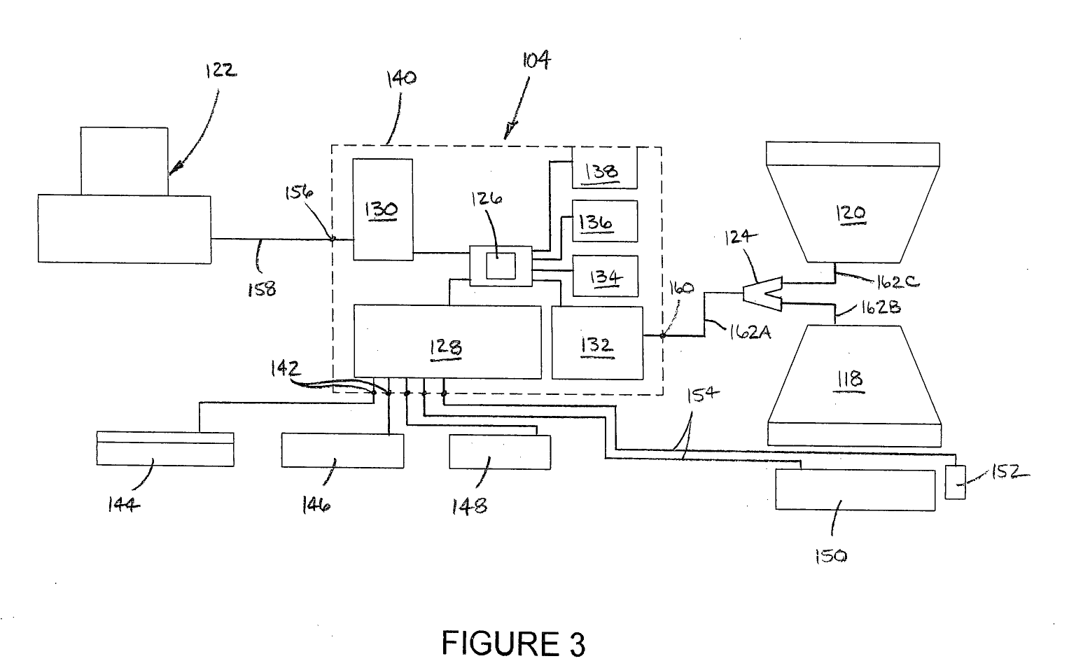

Turning now to FIG. 3, image input and modification system 104 is in communication with a first display 118 and optionally with a second display 120 through a suitable connector arrangement, such as a y-adapter 124, for example. Additionally, system 104 is in communication with a suitable output device, such as a printer 122. Image input and modification system 104 includes a processor 126, an input adapter 128, and output adapter 130 and a display adapter 132. Each of adapters 128, 130 and 132 is in communication with processor 126. System 104 also includes a memory device 134, a data storage device 136, and a removable storage device 138 each in communication with processor 126. The various components of system 104, including items 126-138, are shown in FIG. 3 as being assembled in casing 140. One example of a suitable embodiment of system 104 and the components thereof takes the form of a personal computer or PC, as are generally well known and commonly used. It will be appreciated, however, that system 104 can take any suitable shape, form or configuration without departing from the principles of the present invention.

Input adapter 128 includes a plurality of input ports 142 provided on casing 140. Suitable input devices, such as a scanner 144, a memory card reader 146, a camera interface 148, a keyboard 150 and a mouse 152, for example, are connected to input ports 142 via suitable input cables 154, as are well known and commonly used. Additionally, output adapter 130 includes an output port 156 provided on casing 140. Printer 122 is connected to output port 156 using a suitable output cable 158 as are well known and commonly used. Furthermore, display adapter 132 includes a display port 160 provided on casing 140. Displays 118 and 120 are shown in FIG. 3 as being connected to display port 160 via display cables 162A, 162B and 162C through y-adaptor 124.

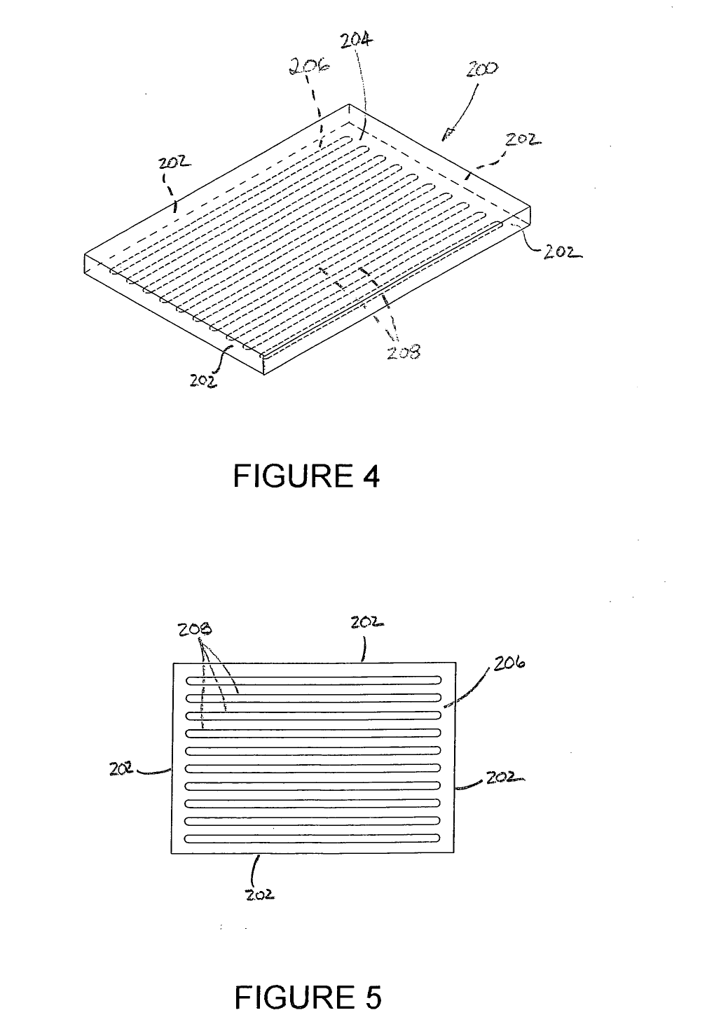

FIGS. 4 and 5 illustrate one embodiment of a heat dissipation plate 200 suitable for use as a heat dissipation element 112 shown in and discussed with regard to FIG. 1. Heat dissipation plate 200 is shown in FIGS. 4 and 5 as being substantially rectangular in shape having four edge walls 202. It will be appreciated, however, that any shape or configuration can be used without departing from the principles of the present invention. Heat dissipation plate 200 also includes opposing top and bottom surfaces 204 and 206, respectively. Preferably, top surface 204 is substantially planar and provides a suitable surface for allowing flat, polymeric printed articles to cool while minimizing warpage and deformation. Bottom surface 206 includes a plurality of slots 208 that extend into plate 200 toward top surface 204. Alternately fins projecting outwardly from bottom surface 206 or any other suitable surface increasing geometry that has the effect of improving heat transfer from plate 200 can be used. To maximize the rate at which heat is transferred or otherwise received from the printed articles placed on top surface 204 to cool, plate 200 is preferably formed from a material having a relatively high coefficient of thermal conductivity, such as from about 40 W/m·K [23 BTU/hr·ft·° F.] to about 410 W/m·K [237 BTU/hr·ft·° F.], for example. Examples of suitable materials include metallic materials, such as aluminum and copper.

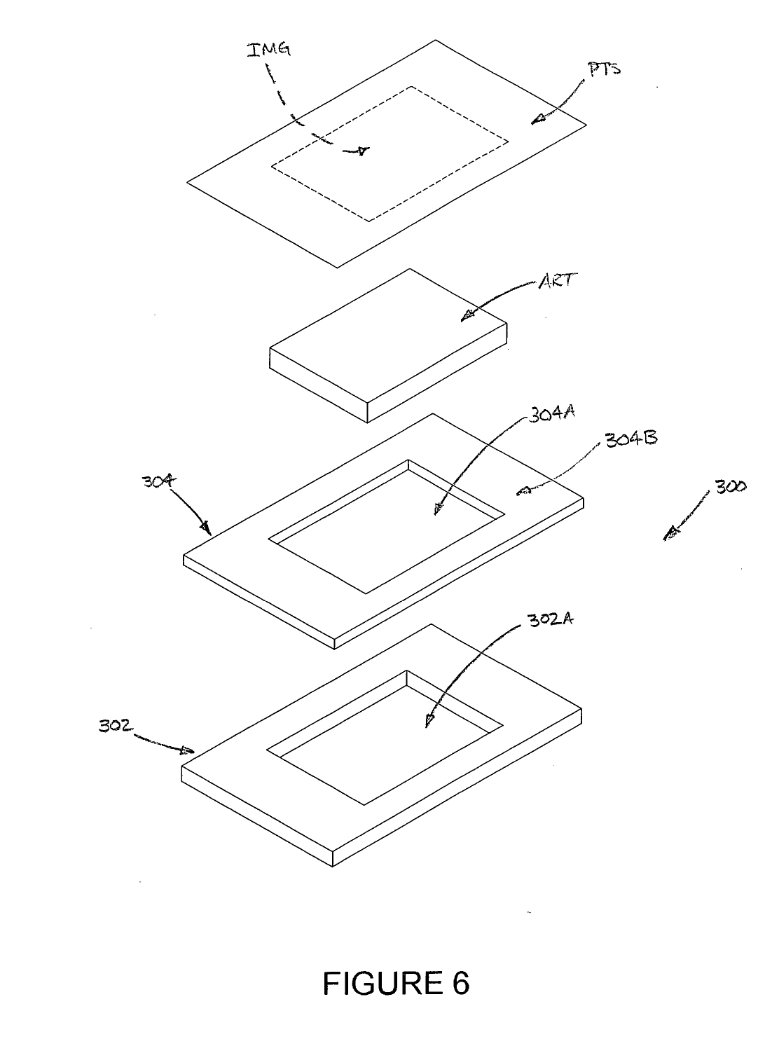

FIGS. 6-9 illustrate various embodiments of alignment fixtures 300, 400 and 500, which are collectively shown in FIG. 1 as alignment fixtures 110. Turning first to FIG. 6, alignment fixture. 300 is shown prior to assembly with an unprinted article ART and a printed transfer sheet PTS. Fixture 300 includes a substantially rigid base portion 302 and an at least partially compressible second portion 304. Portions 302 and 304 are shown in FIG. 6s being separate and independent from one another. However, it will be appreciated that this exploded arrangement is shown purely for the purposes of illustration and that under normal use these two parts are assembled together to form a unitary alignment fixture. In one preferred embodiment, base portion 302 is formed from a metal or thermoplastic material, and secondary portion 304 is formed from a heat-resistant silicon foam rubber material. Alignment fixture 300 is shown in FIG. 6 as being rectangular in shape. Preferably, the alignment fixture is substantially the same size and shape as printed transfer sheet PTS. A nest or cavity (not numbered) receiving article ART is formed by openings 302A and 304A in portions 302 and 304, respectively. Preferably, the nest is dimensioned such that there is only a limited amount of clearance around the periphery of article ART when the same is received within the nest. This desirably assists in maintaining the article in the proper position relative to the external periphery of the alignment fixture or any other alignment guide or feature that is used.

Though it is not apparent from FIG. 6, the thickness of portions 302 and 304 when assembled together are preferably substantially the same thickness as that of article ART. Since opening 302A extends all the way through base portion 302, a bottom surface of the article rests on a bottom platen of the press when the article is received in the nest of the alignment fixture. Furthermore, since the thicknesses of the fixture and the article are substantially equal, top surface 304B of second portion 304 is then substantially aligned with the top surface of unprinted article ART. It will be appreciated that due to the compressibility of second portion 304, it may be, in some cases, desirable to have top surface 304B project slightly above the top surface of the unprinted article.

Once the unprinted article is situated within the nest of alignment fixture 300, printed transfer sheet PTS is arranged such that a printed image IMG thereon is facing the unprinted surface of the article and is in the proper orientation relative thereto. The printed transfer sheet is then place don top of the unprinted article and the corners (or other suitable features) of the transfer sheet are aligned with a pre-determined alignment feature, such as the outside corners of the alignment fixture. It will be appreciated, however, that any suitable pre-determined alignment guide or feature can be used for alignment of the printed transfer sheet. Since the image to be transferred has been printed in a corresponding pre-determined position on the transfer sheet, the alignment of the transfer sheet with the alignment fixture properly positions the image on the unprinted article. In this way, positioning of the image in direct relation to the unprinted article is eliminated, and the image can be easily and correctly positioned relative to the unprinted article. Optionally, a handle (not shown) or other suitable feature can be provided on the alignment fixture to assist in moving the same into and out of the transfer press.

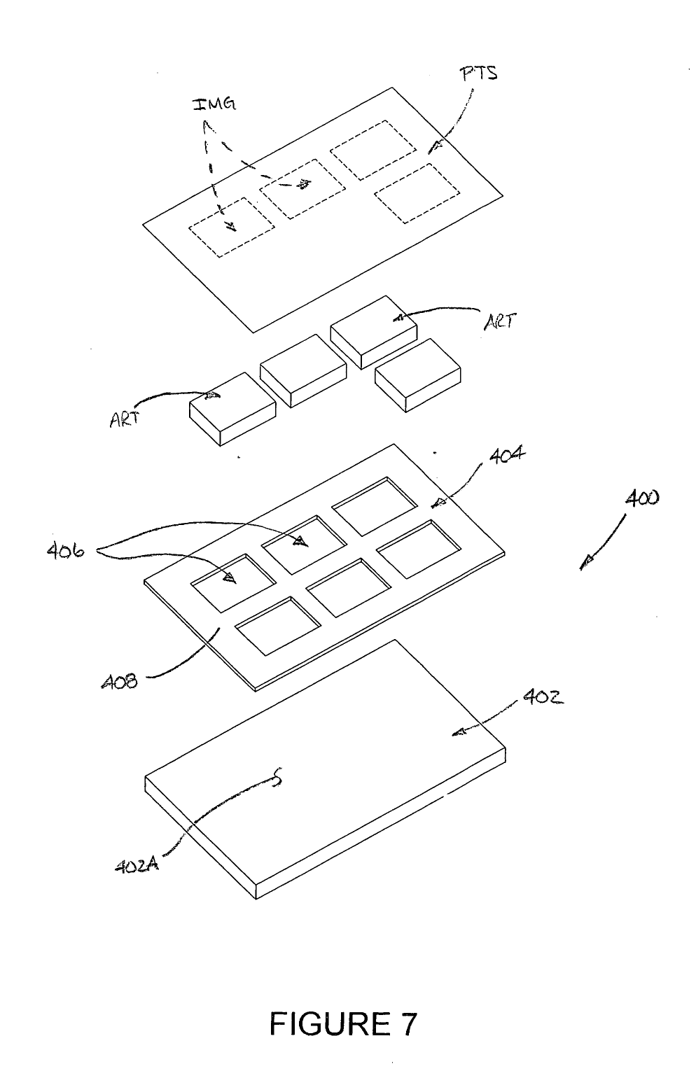

FIG. 7 illustrates another embodiment of an alignment fixture 400 shown prior to use with a plurality of unprinted articles ART and a printed transfer sheet PTS having a plurality of printed images IMG to be transferred. Alignment fixture 400 includes a base portion 402 and an upper portion 404 and is shown in FIG. 7 in an exploded configuration with upper portion 404 separate from base portion 402. However, it will be appreciated that the two portions of the alignment fixture are shown in this exploded arrangement purely for the purposes of illustration and that, under normal use, these two portions are assembled together in a unitary construction.

In one preferred embodiment, base portion 402 is formed from an at least partially compressible material, such as a heat-resistant silicon rubber foam, for example. In this preferred embodiment, upper portion 404 is formed from a substantially rigid material, such as a metal or thermoplastic, for example. Base portion 402 is shown in FIG. 7 as being rectangular in shape and having a substantially planar top surface 402A. Upper portion 404 is of substantially the same shape and size as base portion 402. Preferably, however, the alignment fixture is substantially the same size and shape as the transfer sheets that are to be used. It will be appreciated, however, that any suitable shape and/or corresponding alignment guide or feature can be used. Additionally, a plurality of nests or cavities 406 extend through upper portion 404 that are not present in base portion 402. As such, top surface 402A of base portion 402 acts as a bottom wall of each of nests 406. A handle (not shown) or other suitable feature can optionally be provided on alignment fixture 400 to assist in moving the same into and out of the transfer press.

In use, each article ART is received in one of nests 406 and is supported therein on top surface 402A of base portion 402. Preferably, nests 406 are suitably sized and shaped to receive articles ART with a minimal amount of clearance between the periphery of the article and the walls forming the openings. As such, the articles will have a close fit in the openings to minimize the movement of the articles within the openings and relative to any alignment feature used to align the printed transfer sheet. Though it is not apparent from FIG. 7, upper portion 404 is preferably of a suitable thickness such that the unprinted surface of the articles is substantially even with or projects slightly above the top surface 408 of the upper portion of the alignment fixture. Printed transfer sheet PTS includes a plurality of preprinted images MG on the bottom surface of the sheet. It will be appreciated that in this embodiment, the alignment fixture is substantially the same size and shape as the transfer sheet, as is discussed above. Additionally, images IMG are printed in pre-determined positions on the transfer sheet to be in the correct position relative to the unprinted surfaces of the articles when the transfer sheet is aligned with the alignment fixture.

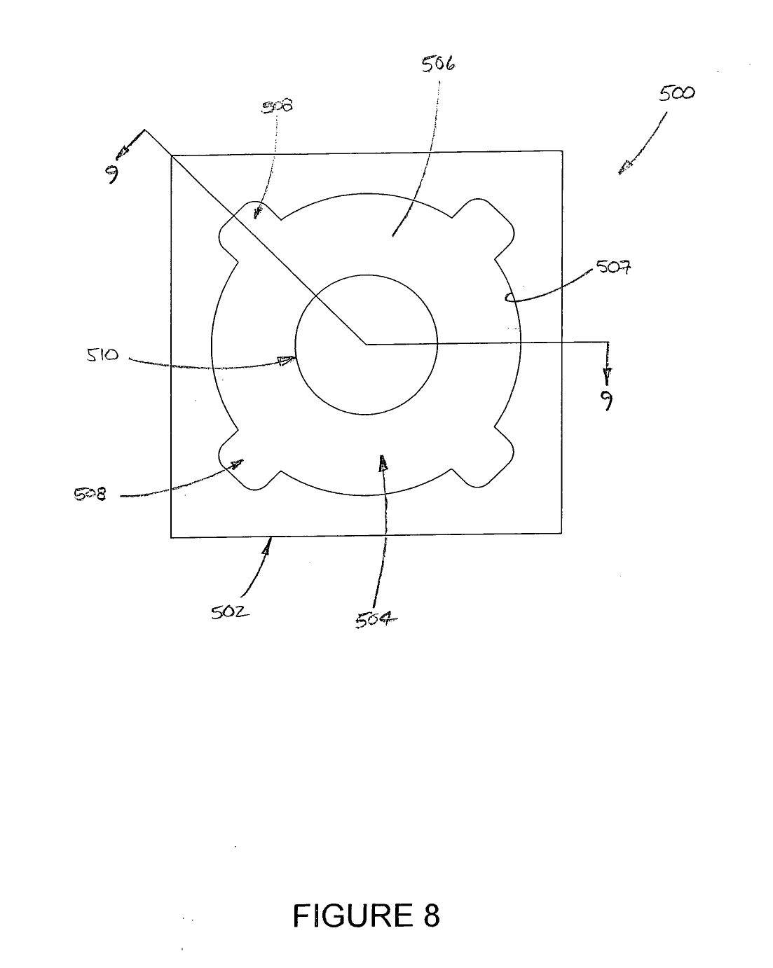

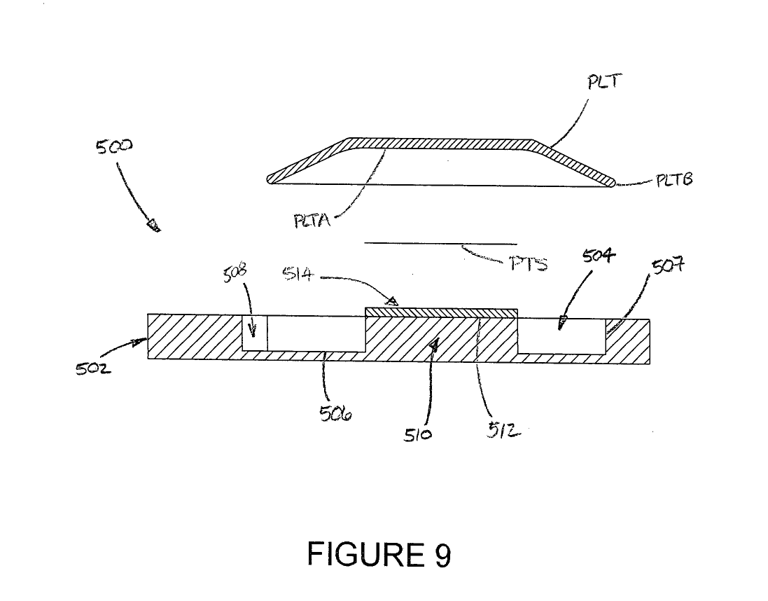

FIGS. 8 and 9 illustrate another embodiment of an alignment fixture 500 that includes a base member 502 having a cavity 504 extending into base portion 502 and forming a bottom wall 506 and a peripheral outer wall 507. In this embodiment, cavity 504 has a generally circular shape and includes radially outwardly extending access pockets 508. The alignment fixture 500 shown in FIGS. 8 and 9 includes four circumferentially-spaced access pockets 508 that are somewhat rectangular in shape, but it will be appreciated that any suitable quantity, shape and/or configuration can be used. Projecting upwardly from bottom surface 506 is a substantially cylindrical boss 510 that is positioned centrally within cavity 504. Boss 510 includes a generally planar top surface 512 upon which a conformable pad 514 is secured. In one preferred embodiment, pad 514 is formed from an at least partially compressible material, such as a heat-resistant silicon rubber foam, for example. A printed transfer sheet PTS having a printed image (not shown) to be transferred and an unprinted article, such as a plate PLT, for example, to receive the transfer image are shown spaced from alignment fixture 500. It will be appreciated that the transfer image on printed transfer sheet PTS will face surface PLTA of plate PLT to receive the image.

In use, the printed transfer sheet and plate are supported on pad 514 and boss 510. The outer edge PLTB of plate PLT is received within cavity 504 such that the edge preferably does not contact bottom surface 506. Access pockets 508 are provided for easy transfer of the plate into and out of the cavity. As such, the access pockets can be of any suitable size, shape or configuration without departing from the principles of the present invention. The alignment fixture, printed transfer sheet and plate are together placed into the transfer press and the bottom of the plate contacts the heated upper platen of the transfer press to heat the plate and the dye forming the image to be transferred. A handle (not shown) or other suitable feature can optionally be provided on the alignment fixture to assist in moving the same into and out of the transfer press.

The foregoing discussion of alignment fixtures 300, 400 and 500 illustrate the use of cavities designed to receive generally rectangular articles and circular plates. However, it will be appreciated that articles of a wide variety of shapes and sizes are commonly custom printed. The examples of alignment fixtures discussed herein may not appear to have suitable cavities for receiving, positioning and properly supporting each of this wide variety of articles. However, the examples described herein are not intended to be limiting. Rather, the unprinted articles and cavities therefor discussed within this disclosure are merely intended to represent generic articles and the claims hereof are not intended to be in any way limited by the size or shape of the articles and cavities shown and discussed.

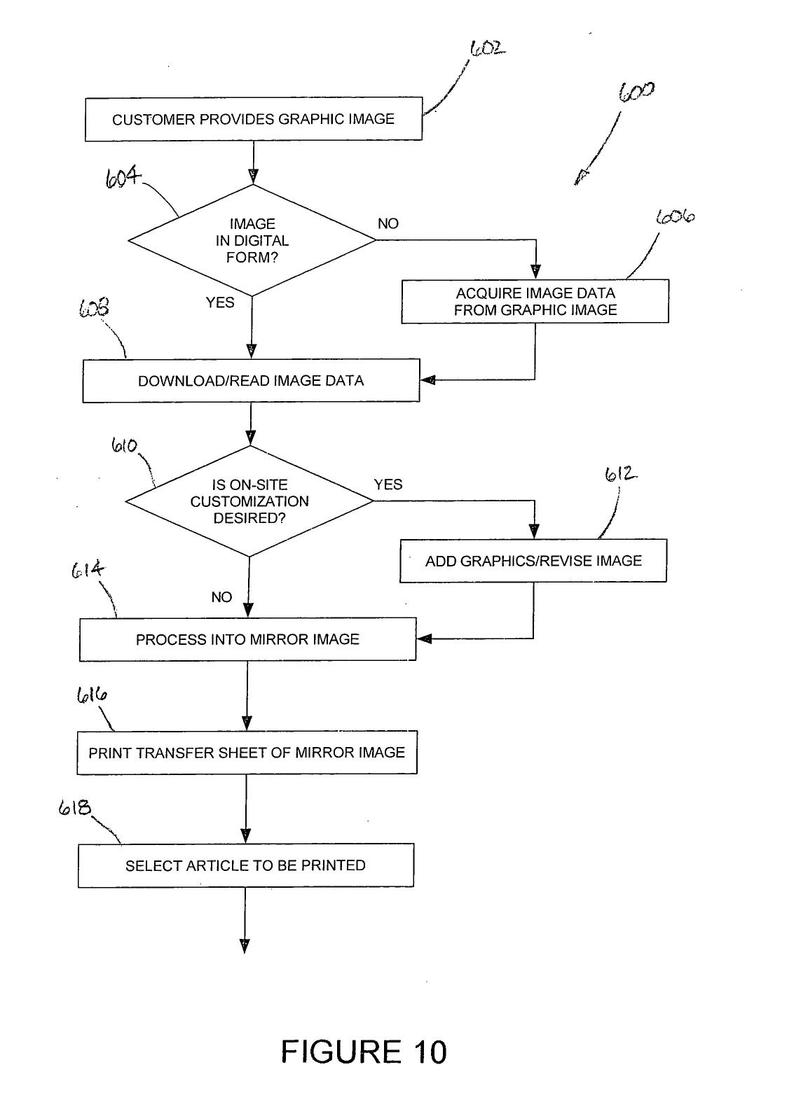

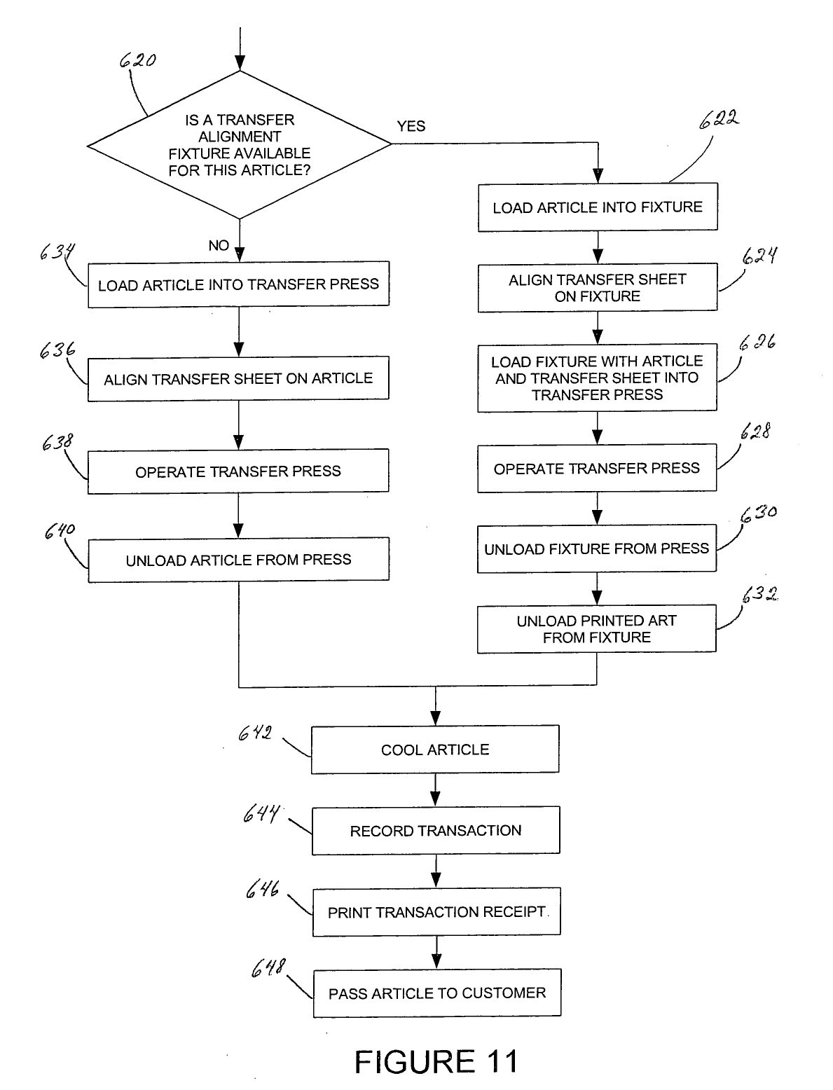

FIGS. 10 and 11 illustrate a flow chart of steps in a method 600 of providing a custom printed article. As a preliminary step 602, a customer presents him or herself and has a graphic image in his or her possession, either mentally or physically. It will be appreciated that such a graphic image can include text, symbols, illustrations, pictures or photographs, or any other visual materials or combination thereof that a customer desires to have printed on an article. Once a customer has approached the workstation and indicated a desire to have an article custom printed with the graphic image, the operator of the workstation inquires in step 604 whether the image is in digital form. If the image is not in digital form, then the operator uses a suitable image acquisition device, such as a scanner 144 (FIG. 1), for example, to acquire a digital version of the graphic image as indicated in step 606. If the customer's graphic image is in digital form or once the digital version has been acquired in step 606, the digital image data is downloaded or read as indicated by step 608. The data can be downloaded or read into an image input and modification system, such as item 104 shown in FIGS. 1 and 3, for example. Next, the workstation operator inquires in step 610 as to whether additional on-site customization of the graphic image is desired by the customer. Where the customer desires further customization, the operator adds graphics, text or otherwise revises the graphic image as desired by the customer, as indicated in step 612. Additionally, it will be appreciated that the customer can monitor and approve the changes to the graphic image on second display 120 (FIGS. 2 and 3). If, in step 610, the customer does not desire additional on-site customization or where the graphic image has been revised in step 612, the graphic image data is then processed into a mirror image in step 614. Thereafter, the mirror image is output to a suitable output device as shown in step 616. One example of a suitable output device is an ink-jet printer, which generates a printed transfer sheet having the mirror image formed thereon from a transferable ink or dye. In another step 618, the customer selects or otherwise presents to the operator those one or more articles to be printed with the customized image. It will be appreciated, however, that step 618 will often occur far earlier in the process, such as in conjunction with step 602, for example, in which the customer provides the graphic image.

In another step 620, the operator of the workstation determines whether an alignment fixture is available for the article that is to be printed. Where such an alignment fixture is available, the operator loads the unprinted article into an appropriate alignment fixture as indicated by step 622. In step 624, the operator aligns the transfer sheet on the alignment fixture with the graphic image facing and properly oriented with regard to the surface of the unprinted article. Thereafter, the operator loads the fixture with the article and the transfer sheet into the transfer press as shown in step 626 and operates the transfer press as shown in step 628. Once the article and the transfer sheet have been pressed together for a sufficient time and at a suitable temperature, the alignment fixture, the now printed article and the used transfer sheet are unloaded from the press ass indicated by step 630. The now printed article can be thereafter unloaded from the alignment fixture as indicated by step 632.

Where no alignment fixture is available for the article in step 620, the article is loaded into the transfer press by itself as indicated in step 634. Thereafter, the printed transfer sheet is aligned on the article as indicated in step 636 and the transfer press operated as shown in step 638. Once the surface of the article and transfer sheet have been compressed within the press for a sufficient time and at a suitable temperature, the now printed article is unloaded from the transfer press as indicated by step 640.

Having unloaded the article from the press in step 640 or from the alignment fixture in step 632, the now printed article is allowed to cool in step 642. This can be done in any suitable manner and will vary from article to article. One suitable method of cooling the article includes placing the same on the heat dissipation element 112, for example. As an optional step thereafter, the operator can record a transaction for custom printing the article as indicated in step 644 and print a transaction receipt as indicated in step 646. Thereafter, the operator can pass the now cool custom printed article to the customer completing the transaction as indicated by step 648.

While the invention has been described with reference to the foregoing embodiments and considerable emphasis has been placed herein on the structures and structural interrelationships between the component parts of the embodiments disclosed, it will be appreciated that other embodiments of the invention can be made and that many changes can be made in the embodiments illustrated and described without departing from the principles of the invention. Obviously, modifications and alterations will occur to others upon reading and understanding the preceding detailed description. Accordingly, it is to be distinctly understood that the foregoing descriptive matter is to be interpreted merely as illustrative of the present invention and not as a limitation. As such, it is intended that the invention be construed as including all such modifications and alterations insofar as they come within the scope of this disclosure.

1. A workstation for producing a printed article using a transferable marking substance, said workstation comprising:
a workstation frame;
an output device supported on said frame, said output device adapted to output a transfer sheet having an image formed thereon form the transferable marking substance; and,
a transfer press supported on said frame, said transfer press having a heating element suitable for transferring the marking substance from said sheet to the article.

2. A workstation according to claim 1 further comprising a heat dissipation element supported on said frame and suitable for receiving heat from the article.

3. A workstation according to claim 1 further comprising an input device for receiving said image, said input device being supported on said frame and in communication with said output device for transferring data corresponding to said image to said output device.

4. A workstation according to claim 3 further comprising a processor in communication with said input device, said processor adapted to receive said image form said input device and output data corresponding to a mirror image of said received image to said output device.

5. A workstation according to claim 1 further comprising an alignment fixture supporting the article within said transfer press.

6. A workstation according to claim 5, wherein said alignment fixture has an alignment guide and said transfer sheet is cooperable with said alignment guide to position said image on said transfer sheet along the article as desired.

7. A workstation according to claim 6, wherein said alignment guide is a peripheral edge of said alignment fixture.

8. A retail system for producing a printed article having a customer-provided image, said retail system comprising:
an image input device for receiving the customer-provided image;
a processor in communication with said image input device, said processor adapted to output data corresponding to a mirror image of the provided image from said input device;
an output device in communication with said processor and adapted to receive said data corresponding to said mirror image, said output device suitable for producing a transfer sheet having said mirror image formed thereon from a quantity of transferable dye; and,
a transfer press having a heating element adapted to transfer said dye on said transfer sheet to the article thereby forming the provided image thereon.

9. A retail kiosk for production and sale of a printed article having a customer-provided image, said kiosk comprising:
a kiosk structure;
a storage device supported on said structure for receiving a digitized version of the customer-provided image;
a processor supported on said structure and in communication with said storage device, said processor adapted to output data corresponding to a mirror image of said digitized version of the customer-provided image;
an output device supported on said structure and in communication with said processor, said output device adapted to output a transfer sheet having said mirror image thereon formed from a quantity of transferable dye; and,
a transfer press supported on said structure and having a heating element suitable for transferring said dye onto an unprinted surface of an article.

10. A retail kiosk according to claim 9 further comprising a transaction recording device operatively associated with said structure and suitable for recording a sales transaction with a customer for the printed article.

11. A retail kiosk according to claim 9, wherein said kiosk structure is a single, free-standing structure.

12. A heat dissipation element adapted for operative association with a transfer printing workstation, said heat dissipation element comprising a body having a substantially planar top wall and a bottom wall, said bottom wall including a heat transfer surface increasing the surface area of said body.

13. A heat dissipation element according to claim 12, wherein said transfer surface includes a groove extending into said body.

14. A heat dissipation element according to claim 12, wherein said body is formed from a metallic material having a coefficient of thermal conductivity of at least about 40 W/m·K.

15. A transfer printing fixture for use in operative association with an unprinted article and a printed transfer sheet having a peripheral edge, said fixture comprising:
a lower portion having a first peripheral edge;
an upper portion having a second peripheral edge; and,
a cavity formed in at least one of said lower portion and said upper portion, said cavity dimensioned to receive at least a portion of the unprinted article;
at least one of said first and second peripheral edges being accessible such that the peripheral edge of the transfer sheet can be aligned therewith.

16. A transfer printing fixture according to claim 15, wherein said first and second peripheral edges extend along one of an inside wall and an outside wall of said lower and upper portions.

17. A transfer printing fixture according to claim 15, wherein said base portion is formed from a substantially rigid material and has a first opening at least partially forming said cavity.

18. A transfer printing fixture according to claim 17, wherein said substantially rigid material is one of a polymeric material and a metallic material.

19. A transfer printing fixture according to claim 17, wherein said upper portion is formed from a compressible material and has a second opening at least partially forming said cavity.

20. A transfer printing fixture according to claim 19, wherein said compressible material is a heat-resistant silicon rubber foam.
